(19) United States
(12) Patent Application Publication
(10) Pub. No.: US 2008/0031683 A1
(43) Pub. Date: Feb. 7, 2008

(54) Rotary adapter

(76) Inventor: Pin Chao, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/497,473

(22) Filed: Aug. 2, 2006

(51) Int. Cl. F16C 11/00

(52) U.S. Cl. 403/122

(57) ABSTRACT

A rotary adapter includes of a left and right connection parts having through-holes for transfixing cables. The left connection part is provided with a rotor body, the right connection part is provided with a rotary seat to fit with the rotor body, and the rotary seat is larger than the rotor body such that the rotary body can be latched into the rotary seat. A through-hole is opened along a direction of diameter of the aforementioned rotor body. Two steel beads are defined in the through-hole, and a spring is fixed between the two steel beads. Grooves are opened symmetrically in the rotary seat of the right connection part to fit with the steel beads. The left and right connection parts are connected with a connector respectively, and through a rotation of the rotor body in the rotary seat, a rotation of two-way connector can be implemented.

### BACKGROUND OF THE INVENTION

(a) Field of the Invention

The present invention relates to technology of an adaptive terminal, and more particularly to a rotary adapter which is used in a two-way adaptive terminal.

(b) Description of the Prior Art

As development of science and technology, all kinds of electronic equipment, such as TVs or computers, are more and more broadly used. During a process of utilization, an adapter is developed to solve a problem of adaptation between all kinds of electronic products, such that a data transmission can be implemented between different cables and different electronic products. Most of the existing adapters are provided with an integrated structure, wherein their two-way connectors are all fixed on a seat, and thus the connectors are at fixed positions without being able to rotate, which will bring a certain inconvenience to a user.

### SUMMARY OF THE INVENTION

The primary object of present invention is to provide a rotary adapter to be used in a two-way adaptive terminal, in order to complement an insufficiency of the existing technology.

Accordingly, the present invention includes a left and right connection parts on which are all opened with through-holes for transfixing cables. The left connection part is provided with a rotor body, and the right connection part is provided with a rotary seat to fit with the rotor body. The covering surface of the rotary seat is larger than one half of the square measure of the rotor body, and the rotor body is latched into the rotary seat.

A through-hole is formed along a direction of diameter of the aforementioned rotor body, and two steel beads are defined in the through-hole. A spring is fixed between the two steel beads, and a radius of the steel bead is larger than that of the through-hole.

Grooves are opened symmetrically in the rotary seat of aforementioned right connection part to fit with the steel beads.

The left and right connection parts of present invention are connected with a connector respectively, and through a rotation of the rotor body in the rotary seat, a rotation of two-way connector can be implemented, which is very convenient to use.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of the present invention.

FIG. 2 shows a perspective view of the present invention.

FIG. 3 shows a schematic view of the present invention being used in a USB connector.

### DETAILED DESCRIPTION OF THE PREFERRED EMBODIMENTS

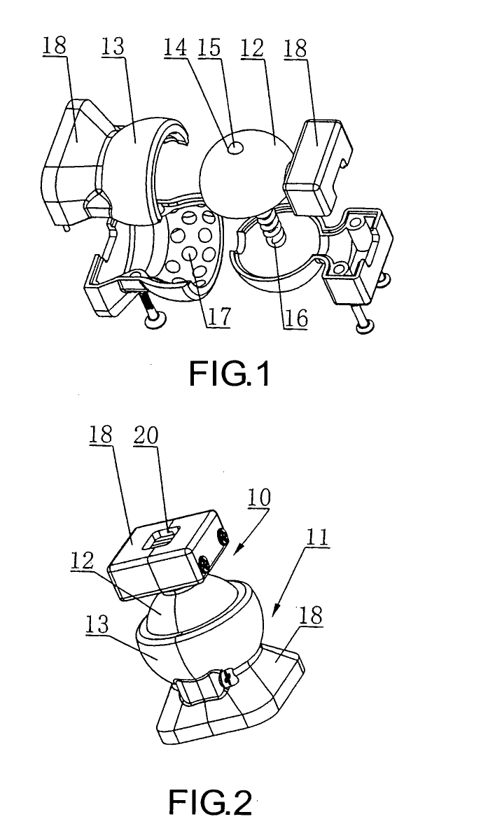

Referring to FIG. 1 and FIG. 2, the present invention comprises a left and right connection parts 10, 11 on which are all opened with through-holes 20 for transfixing cables. The left connection part 10 is provided with a rotor body 12, and the right connection part 11 is provided with a rotary seat 13 which can fit with the rotor body 12. The covering surface of the rotary seat 13 is larger than one half of the square measure of the rotor body 12, such that the rotor body 12 can be latched into the rotary seat 13 without being able to release.

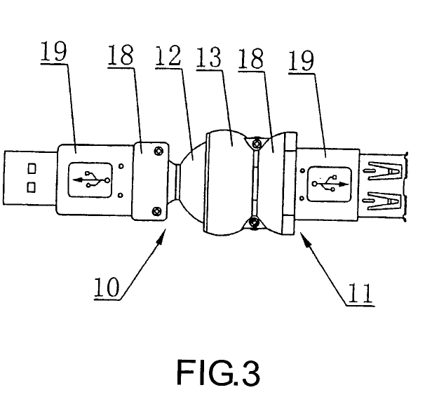

Referring to FIG. 3, a USB (Universal Serial Bus) adapter is provided as an embodient.

The left and right connection parts 10, 11 are all provided with an end part 18 respectively to be fixedly connected with a USB connector 19. To facilitate a manufacturing, the left and right connection parts 10, 11 are all divided into an upper and lower part which are first processed, and then are assembled into a whole body.

The left connection part 10 is provided with the rotor body 12, whereas the rotor body 12 and the end part 18 are all opened with the through-holes 20 for transfixing data lines. The right connection part 11 is provided with the rotary seat 13 to fit with the rotor body 12, whereas the rotary seat 13 and the end part 18 are all opened with the through-holes 20 for transfixing data lines. The covering surface of the rotary seat 13 is larger than one half of the square measure of the rotor body 12, such that the rotary body 12 can be latched into the rotary seat 13 without being able to release, and that the rotary body 12 can only rotate in the rotary seat 13.

A through-hole 14 is opened along a direction of diameter of the rotor body 12, and in general, the through-hole 14 is opened in a direction perpendicular to the USB connector. Two steel beads 15 are defined in the through-hole 14, and a spring 16 is fixed between the two steel beads 15. A radius of the steel bead 15 is larger than that of the through-hole 14, therefore the steel bead 15 cannot pass out of the through-hole 14. By using this kind of structure, each time when the rotor body 12 rotates, it can be guaranteed that one steel bead 15 will be fallen inside the rotary seat 13.

Grooves 17 are symmetrically opened in the rotary seat 13 of right connection part 11, in order to fit with the steel beads 15.

Upon rotating the rotor body 12, the steel beads 15 will be squeezed by the rotary seat 13, and under a reaction of the spring 16, the steel beads 15 will fit and be positioned with the grooves 17 in the rotary seat 13; therefore, after the rotor body 12 rotates by a certain angle, the steel beads 15 will not swing.

Due to that the rotary seat 13 is provided with the plural grooves 17, the steel beads 15 can rotate by 360 degrees and be positioned in any one of the grooves 17 by a means of the rotary seat 13.

According to the aforementioned descriptions, the end part 18 which is fixedly connected with the USB connector 19 is formed by assembling an upper and lower part; therefore, a different type of adaptive terminal of connector can be replaced to be assembled for use.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A rotary adapter including a left and right connection parts on which are all opened with through-holes for transfixing cables; the left connection part being provided with a rotor body, the right connector being provided with a rotary seat to fit with the rotor body, the covering surface of the rotary seat is larger than one half of the square measure of the rotor body, and the rotor body being latched into the rotary seat.

2. The rotary adapter according to claim 1, wherein a through-hole is opened along a direction of diameter of the rotor body, wherein two steel beads are defined in the through-hole, wherein a spring is fixed between the two steel beads, and wherein a radius of the steel bead is larger than that of the through-hole.

3. The rotary adapter according to claim 2, wherein grooves are opened symmetrically in the rotary seat of right connection part, to fit with the steel beads.
